(19) United States
(12) Patent Application Publication
(10) Pub. No.: US 2015/0361258 A1
(43) Pub. Date: Dec. 17, 2015

(54) POLY (LACTIC ACID)-BASED BIOCOMPOSITE MATERIALS HAVING IMPROVED TOUGHNESS AND HEAT DISTORTION TEMPERATURE AND METHODS OF MAKING AND USING THEREOF

(71) Applicant: UNIVERSITY OF GUELPH, Guelph (CA)

(72) Inventors: Amar MOHANTY, Guelph (CA); Manju MISRA, Guelph (CA); Kunyu ZHANG, Guelph (CA); Vidhya NAGARAJAN, Guelph (CA)

(21) Appl. No.: 14/762,745

(22) PCT Filed: Jan. 22, 2014
(86) PCT No.: PCT/IB2014/000216

§ 371 Date: Jul. 22, 2015

Related U.S. Application Data
(60) Provisional application No. 61/755,206, filed on Jan. 22, 2013.

(51) Int. Cl. C08L 67/04; C08J 5/00

(52) U.S. Cl. CPC C08L 67/04; C08J 5/00; C08L 2201/06; C08L 2205/03; C08J 2367/04; C08J 2423/08; C08J 2471/00; C08J 2477/00

(57) ABSTRACT

Super tough poly (lactic acid) (PLA)-based blends showing non break impact behavior have been developed. The blend contains a PLA resin, (b) a thermoplastic elastomeric block copolymer, and (c) a functionalized polyolefin copolymer. The blend is used as matrix to incorporate one or more additives, such as fillers (e.g., natural fibers and/or mineral fillers), nucleating agents, and/or chain extenders to form composites. In some embodiments, the blend is the continuous phase and the one or more additives are the dispersed phase. The composites exhibit improved impact strength and heat distortion temperature compared to neat or virgin PLA. For example, in some embodiments, the impact strength of the composite is from about 60 J/m to about 140 J/m and/or the HDT of the composite ranges from about 60 to about 115° C.

### FIELD OF THE INVENTION

The present invention is in the field of poly (lactic acid) blends which exhibit significantly improved impact strength compared to neat or virgin poly (lactic acid) and composites containing the blends in combination with fillers, nucleating agents, and/or chain extenders which exhibit improved impact strength and heat distortion temperature compared to neat or virgin poly (lactic acid), and methods of making and using thereof.

### BACKGROUND OF THE INVENTION

Poly (lactic acid) (PLA) is a widely known biodegradable polymer which can be obtained from renewable resources. From energy consumption, CO₂ emissions and end of life standpoints, PLA is superior to many petroleum-based polymers. PLA is an alternative to certain petroleum-based plastics in commercial applications, such as packaging, fiber materials, auto part applications, etc. because of its large scale availability in the market at a reasonable price. Applications of this polymer are however significantly hindered by its low heat distortion temperature (HDT) and inherent brittleness, especially in areas that require high resistance to temperature and sudden impact.

Numerous approaches have been explored to improve the toughness and crystallization of PLA, such as block copolymerization, nucleation and/or plasticization, blending with other polymers, and chemical modification. Chemical modification is typically complex, technically demanding, and expensive due to the cost of required catalysts and/or monomers. Combining nucleating agents with plasticizers has showed an improvement on PLA crystallization kinetics and mechanical properties. However, with long-term use, plasticizers have a tendency to migrate to the surface, which causes embrittlement of the polymer. Furthermore, the low glass transition temperature (T_{g}) may affect the processing and molding of commercial products made from the polymer.

The use of acrylic copolymers to improve impact strength has been described. United States Patent Publication No 2009/0030132 describes a composition containing PLA and methacrylic resins differing in their glass transition temperature and syndiotacticity. The materials form a stereocomplex between the poly L-lactic acid (PLLA) and poly D-lactic acid (PDLA) to allegedly achieve the desired impact strength.

United States Patent Publication No US2012/0095169 describes the use of a polyisocyanate to form amide bonds with PLA which allegedly results in improved impact strength. U.S. Pat. No. 8,076,406 describes a composited containing PLA, polyamide and a functionalized polyolefin that allegedly has impact strength higher than the previously developed composites based only on PLA and polyamide. United States Patent Publication No US 2007/0255013 describes a PLA-based blend for tray, film and sheet applications that contains PLA and one or more of ethylene/unsaturated ester copolymer, modified ethylene/unsaturated ester copolymer, poly (ether amide) block copolymer, propylene/ethylene copolymer and styrenic block copolymer.

United States Patent Publication No US/2005 6869985 B2 describes compression molded PLA based sheet flooring materials containing a combination of a plasticizer, a compatibilizer and optional filler allegedly showing high impact strength.

Chinese Patent Application No. CN 101260228 describes a PLA/natural fiber for use as a flame-retardant material by combining the PLA with surface modified fiber and fire retardant. Chinese Patent Application No. CN 101003667 describes a granulated PLA/natural fiber composite material prepared by melt-extruding PLA and surface treated natural fibers with coupling agents, nucleating agents, anti-oxidants and lubricants. These composites exhibited high HDT but the impact strength was lower than the neat PLA. European patent EP 2 186 846 describes a PLA natural fiber composite in which one form of PLA stereoisomer (PLLA or PDLA) is mixed with a natural fiber that is surface treated with a second form of stereoisomer. Hemp is the fiber component in the formulation and the surface treatment was accomplished either by in situ reaction or melt-mixing in a batch mixer or by physical and chemical dipping processes.

None of the art cited above described concurrent improvement in impact strength and HDT of the PLA composites.

Liu et al., Macromolecules, 44(6), 1513-1522 (2011) and Liu et al., Macromolecules, 43(14), 6058-6066 (2010) describes blends containing PLA, ethylene/butyl acrylate/glycidyl methacrylate, and a zinc ionomer of ethylene/methacrylic acid copolymer as additives in an attempt to improve impact strength. However, Liu is silent regarding the HDT of these blends.

Huda et al., Composites, Part B, 38, 367-379 (2007) and Huda et al., Ind. Eng. Chem. Res., 44(15), 5593-5601 (2005) describe the effect of silane-treated and untreated talc on the mechanical properties of PLA/newspaper fibers/talc hybrid composites. The stiffness of the PLA and HDT was allegedly improved with the talc added, however the impact strength decreased drastically with an increase in the density of the composites.

Baouz et al., J. Appl. Polym. Sci., (2012) describes the combination of ethylene-methyl acrylate-glycidyl methacrylate rubber and organo-montmorillonite (OMMT) to improve the impact strength and elongation of PLA without sacrificing the stiffness. However, only limited improvement in impact strength was achieved and HDT properties were not described.

Nyambo et al., Biomacromolecules, 11, 1654-1660 (2011) describes the effect of adding agricultural residues and their hybrids to PLA and found that only the modulus of the composites increased while impact strength and HDT remained essentially the same as that of virgin or neat PLA.

RTP Co. sell impact modified PLA bioplastics but the exact composition is not known. NatureWorks LLC sells PLA resins, under the tradenames Ingeo™ 2500 HP and 3100 HP, for extrusion and injection molding applications. These resin exhibit high HDT values due to the combination of high molding temperature and incorporation of a nucleating agent. However, the impact strength of the NatureWorks materials is less than 40 J/m.

While the art described above alleges improvement in impact strength or the heat deflection temperature of PLA blends or composites has been observed, improvement in both of these properties has remained difficult to achieve.

Enhancement in impact strength and HDT for PLA/natural fiber composites has been observed with the use of surface treatment. However, this adds another processing step to the fabrication process increasing the time and cost of production.

There is a need for PLA-based blends that exhibit significantly improved impact strength compared to neat or virgin PLA, and methods of making and using thereof.

There is also a need for PLA-based composites prepared from the blends described above which exhibit improved impact strength and heat distortion temperature compared to neat or virgin PLA.

Therefore, it is an object of the invention to provide PLA-based blends that exhibit significantly improved impact strength compared to neat or virgin PLA, and methods of making and using thereof.

It is also an object of the invention to provide PLA-based composites, such as injection molded composites, prepared from the blends described above which exhibit improved impact strength and heat distortion temperature compared to neat or virgin PLA.

It is another object of the invention to provide PLA-based composites prepared from the blends described above which exhibit improved impact strength and heat distortion temperature compared to neat or virgin PLA without the need for chemical surface treatment of the filler material in the composite.

### SUMMARY OF THE INVENTION

Super tough poly (lactic acid) (PLA)-based blends exhibiting non break impact behavior are described. The blend contains a PLA, (b) a thermoplastic elastomeric block copolymer, and (c) a functionalized polyolefin copolymer.

The concentrations of the components in the blend can vary. However, in some embodiments, the concentration of the PLA resin is from about 65 to about 90% by weight of the blend, preferably from about 65% to about 80% by weight of the blend, more preferably from about 65% to about 75% by weight of the blend. The concentration of the thermoplastic elastomeric block copolymer is from about 5% to about 20% by weight of the blend, preferably from about 5% to about 20% by weight of the blend, preferably from about 8% to about 15% by weight of the blend, more preferably from about 10% to about 15% by weight of the blend, most preferably about 10% by weight of the blend. The concentration of the functionalized polyolefin copolymer is from about 10% to about 25% by weight of the blend, preferably from about 15% to about 25% by weight of the blend, more preferably from about 20% to about 25% by weight of the blend, most preferably about 20% by weight of the blend.

The functionalized polyolefin can play a dual role as both a compatibilizer and a toughening agent. The reactive functional groups on the functionalized polyolefin is capable of reacting with carboxyl and hydroxyl end groups present in the other additives and/or PLA thereby improving the toughness of the blend.

Significant improvements in impact strength were achieved in the blends described herein. The blends exhibit non-break type impact behavior. The heat distortion temperature (HDT) of the blends is essentially the same as virgin PLA. PLA is typically the major phase in the blend and the phase morphology of the ternary blend system is a core-shell structure and partial encapsulation which contributes in the significant improvement in toughness.

In order to achieve concurrent improvements in impact strength and HDT relative to virgin PLA, the PLA-based blend is used as a matrix to incorporate one or more additives, such as fillers (e.g., natural fibers and/or mineral filler), nucleating agents, and/or chain extenders. Incorporation of nucleating agents into the blend increases the crystallization speed of PLA, while incorporation of natural fibers improves the rigidity of PLA at high temperatures. The combination of natural fiber and nucleating agent can result in PLA composites having impact strengths in the range of 60 to about 140 J/m and an HDT in the range from about 60° C. to about 115° C. The impact strength and HDT can be tailored by varying the amount and/or type of nucleating agent and/or fiber and processing conditions.

Addition of certain nucleating agents may reduce the molecular weight of the PLA thereby lowering the impact strength of the PLA composites. In order to balance this potential negative effect of nucleating agents, chain extenders can be added to the composites. Chain extenders help to maintain the melt stability of the PLA thereby increasing the impact strength of the composites. In addition, the chain extenders may also help in improving the compatibility between the different phases of the composites.

Another advantageous aspect of adding natural fiber is that it reduces the cost of the final formulation as it replaces a certain amount of the polymer blend matrix according to the property requirements of the end product. Natural fibers were added to the PLA-based blend system directly without any surface treatment (i.e. devoid of surface treatment) to achieve the required performance. Mixtures of two or more fibers in PLA-based composites can also be used, which may enhance the performance of the composites while having balanced strength and HDT. This may be especially important in case of fiber supply chain issues that can arise while using one particular type of fiber.

### BRIEF DESCRIPTION OF THE DRAWINGS

FIG. 1 is a graph showing the impact strength (J/m, y-axis on the left) and heat distortion temperature (HDT, ° C., y-axis on the right) as a function of material.

### DETAILED DESCRIPTION OF THE INVENTION

### I. Definitions

“Composite”, as used herein, generally means a combination of two or more distinct materials, each of which retains its own distinctive properties, to create a new material with properties that cannot be achieved by any of the components acting alone.

“Thermoplastic”, as used herein, refers to a material, such as a polymer, which softens (e.g., becomes moldable or pliable) when heated and hardens when cooled.

“Elastomer”, as used herein, refers to a polymer with that recovers most or all of its original shape after being subjected to a significant strain. An elastomer generally displays low Young's modulus and high failure strain compared with other materials.

The prefix “bio-” as used herein refers to a material that has been derived from a renewable resource.

The term “renewable resource”, as used herein, refers to a resource that is produced by a natural process at a rate comparable to its rate of consumption (e.g., within a 100 year time frame). The resource can be replenished naturally or via agricultural techniques.

The term “bio-based content”, as used herein, refers to the amount of bio-carbon in a material as a percent of the weight (mass) of the total organic carbon in the product.

“Recyclable”, as used herein, refers to a product or material that can be reprocessed into another, similar or often different products.

“Blend”, as used herein, means a homogeneous mixture of two or more different polymers.

The terms “heat deflection temperature” or “heat distortion temperature” (HDT) are used interchangeably and refer to the temperature at which a polymer or plastic sample deforms under a specified load. The heat distortion temperature is determined by the following test procedure outlined in ASTM D648. The test specimen is loaded in three-point bending in the edgewise direction. The two most common loads are 0.455 MPa or 1.82 MPa and the temperature is increased at 2° C./min until the specimen deflects 0.25 mm.

“Impact strength”, as used herein, refers to the capability of a material to withstand a suddenly applied load and is expressed in terms of energy. Impact strength is typically measured with the Izod impact strength test or Charpy impact test, both of which measure the impact energy required to fracture a sample. Izod impact testing is an ASTM standard method of determining the impact resistance of materials. An arm held at a specific height (constant potential energy) is released. The arm hits the sample and breaks it. From the energy absorbed by the sample, its impact energy is determined. A notched sample is generally used to determine impact energy and notch sensitivity.

The terms “super tough” and “non-breakable” are used interchangeably and refer to a polymer blend which shows a no break notched Izod impact behavior, as determined according to ASTM Standard D256.

The term “non-break”, as used herein, refers to an incomplete break where the fracture extends less than 90% of the distance between the vertex of the notch and the opposite side as per ASTM D256. Results obtained from the non-break specimens shall not be reported as per ASTM D256.

### II. PLA-Based Blends

Super tough poly (lactic acid) (PLA)-based blends showing non break impact behavior have been developed. In one embodiment, the PLA-based blend may include (a) a poly (lactic acid) (PLA), (b) a thermoplastic elastomeric block copolymer, and (c) a functionalized polyolefin copolymer. The PLA-based blend may serve as a matrix for the manufacture of PLA-based composites.

A. Polylactic Acid

Polylactic acid (PLA) is a renewable polymer derived from naturally sourced monomers and derivatives thereof. PLA is a commercially-available polyester-based resin made using lactic acid. The lactic acid may be obtained, for example, by decomposing biomass, such as corn starch, to obtain the monomer. In some embodiments, the PLA is a homopolymers of lactic acid, including poly(L-lactic acid) in which the monomer unit is L-lactic acid, poly(D-lactic acid) in which the monomer unit is D-lactic acid, and poly(D,L-lactic acid) in which the monomer structure units are D,L-lactic acid, that is, a mixture in various proportions (e.g., a racemic mixture) of D-lactic acid and L-lactic acid monomer units. In other embodiments, the PLA is a stereocomplex PLLA and PDLA. In other embodiments, polylactic acid resins which are crosslinked may be used.

In other embodiments, the PLA is a copolymer of lactic acid containing at least about 50, 60, 70, 80, or 90 wt. % lactic acid comonomer content based on the weight of the copolymer and containing one or more comonomers other than lactic acid comonomer in amounts of less than 50, 40, 30, 20, or 10 wt %, by weight of the copolymer. Exemplary comonomers include, but are not limited to, hydroxycarboxylic acids other than lactic acid, for example, one or more of any of the following hydroxycarboxylic acids: glycolic acid, hydroxybutyrate (e.g., 3-hydroxybutyric acid, 4-hydroxybutyric acid), hydroxyvaleric acid (e.g., 4-hydroxyvaleric acid, 5-hydroxyvaleric acid) and hydroxycaproic acid (e.g., 6-hydroxycaproic acid).

In one embodiment, PLA is virgin PLA. In some embodiments, the PLA has high optical purity. Using PLA of high optical purity may improve the HDT of the composites prepared from PLA. The weight average molecular weight of the PLA can vary. However, in some embodiments, the average molecular weight of the PLA is from about 10,000 and 500,000 Dalton, preferably from about 10,000 to about 300,000 Daltons.

The PLA may be the major component or phase of the blend and composites described herein. In some embodiments, the content of the PLA in the blend is from about 65 percent by weight (wt %) of the blend to about 90 wt % of the blend, preferably from about 65% to about 85% by weight of the blend, more preferably from about 65% to about 80% by weight of the blend, most preferably from about 65% to about 75% by weight of the blend. In some embodiments, the content of PLA is about 70% by weigh of the blend. In embodiments where PLA is the major phase in the blend, the morphology of the blend can be a core-shell structure and partial encapsulation which likely contributes to the significant improvement in toughness.

In some embodiments, PLA generated as post-consumer and post industrial waste, which can be used in place of virgin PLA or in combination with virgin PLA, may also be used in the blends and composites described herein. In those embodiments where recycled PLA is used, the recycled PLA has a relatively high weight average molecular weight, such as at least about 50,000, 60,000, 70,000, 75,000, 85,000, 90,000, 95,000, or 100,000 Daltons. In some embodiments, the weight average molecular weight is from about 5,000 Daltons to about 100,000 Daltons. In other embodiments, the weight average molecular weight is from about 70,000 to about 100,000 Daltons. In particular embodiments, the PLA is crystalline and has the molecular weight described above. In those embodiments wherein recycled PLA is used in combination with virgin PLA, the concentration of recycled PLA is from about 10 wt % to about 30 wt % of the combination of recycled PLA and virgin PLA.

Virgin or neat PLA refers to formulations containing only PLA. The impact strength of virgin or neat PLA is 31.1 J/m and its HDT is 55° C.

B. Functionalized Polyolefin Copolymer

The blend also contains a functionalized polyolefin copolymer. “Functionalized polyolefin copolymer”, as used herein, refers to a polyolefin contain one or more co-monomers containing reactive functional groups, particularly groups that can react with hydroxyl and/or carboxyl groups. Exemplary reactive functional groups include, but are not limited to, activated carboxylic acid groups, such as ester groups, acid chlorides, and anhydrides; epoxide groups; cyclic anhydrides, such as maleic anhydrides; and combinations thereof.

The blend may contain ethylene/unsaturated ester copolymer. Ethylene/unsaturated ester copolymer includes copolymers of ethylene and one or more unsaturated ester monomers. Suitable unsaturated esters include (1) vinyl esters of aliphatic carboxylic acids, where the esters have from 4 to 12 carbon atoms, (2) alkyl esters of acrylic or methacrylic acid, where the esters have from 4 to 12 carbon atoms, and (3) glycidyl esters of acrylic or methacrylic acid. The ethylene/unsaturated ester copolymer may contain a mixture of the second and third types of comonomers, for example to form an ethylene/alkyl(meth)acrylate/gylcidyl(meth)acrylate copolymer.

Exemplary examples of the first group of monomers include vinyl acetate, vinyl propionate, vinyl hexanoate, and vinyl 2-ethylhexanoate. The vinyl ester monomer may have at least any of the following number of carbon atoms: 4, 5, and 6 carbon atoms; and may have at most any of the following number of carbon atoms: 4, 5, 6, 8, 10, and 12 carbon atoms.

Representative examples of the second (“alkyl(meth)acrylate”) group of monomers include methyl acrylate, ethyl acrylate, isobutyl acrylate, n-butyl acrylate, hexyl acrylate, and 2-ethylhexyl acrylate, methyl methacrylate, ethyl methacrylate, isobutyl methacrylate, n-butyl methacrylate, hexyl methacrylate, and 2-ethylhexyl methacrylate. The alkyl(meth)acrylate monomer may have at least any of the following number of carbon atoms: 4, 5, and 6 carbon atoms; and may have at most any of the following number of carbon atoms: 4, 5, 6, 8, 10, and 12 carbon atoms.

Representative examples of the third (“gylcidyl(meth)acrylate”) group of monomers include gylcidyl acrylate and gylcidyl methacrylate (“GMA”).

The ethylene/unsaturated ester copolymer may contain (i) vinyl ester of aliphatic carboxylic acid comonomer content of any one or more of the above listed types of vinyl esters of aliphatic carboxylic acids and/or (ii) alkyl(meth)acrylate comonomer content of any one or more of the above listed types of alkyl(meth)acrylates in at least about any of the following amounts (based on the weight of the copolymer): 5, 10, 15, 20, 24, 25, 26, 27, 28, 29, 30, 32, 34, 36, 38, 40, 45, 50, 55, and 60 wt. %; and at most about any of the following amounts (based on the weight of the copolymer): 10, 15, 20, 25, 26, 27, 28, 29, 30, 32, 34, 36, 38, 40, 45, 50, 55, 60, 65, and 70 wt. %.

The ethylene/unsaturated ester copolymer may contain glycidyl(meth)acrylate comonomer content (e.g., any one or more of the above listed types of glycidyl(meth)acrylates) in at least about any of the following amounts (based on the weight of the copolymer): 0.5, 1, 2, 3, 4, 5, 6, 7, 8, 9, and 10 wt. %; and at most about any of the following amounts (based on the weight of the copolymer): 1, 2, 3, 4, 5, 6, 7, 8, 9, 10, and 12 wt. %.

The unsaturated ester comonomer content (e.g., the vinyl ester, alkyl(meth)acrylate, and/or gylcidyl(meth)acrylate comonomer content) of the ethylene/unsaturated ester copolymer may collectively total at least about any of the following amounts (based on the weight of the copolymer): 25, 26, 27, 28, 29, 30, 32, 34, 36, 38, 40, 45, 50, 55, and 60 wt. %; and collectively total at most about any of the following amounts (based on the weight of the copolymer): 30, 32, 34, 36, 38, 40, 45, 50, 55, 60, 65, and 70 wt. %.

The ethylene monomer content of the ethylene/unsaturated ester copolymer may be at least about, and/or at most about, any of the following (based on the weight of the copolymer): 45, 50, 55, 60, 65, 70, and 80 wt. %.

Representative examples of ethylene/unsaturated ester copolymers include: ethylene/vinyl acetate, ethylene/methyl acrylate, ethylene/methyl methacrylate, ethylene/ethyl acrylate, ethylene/ethyl methacrylate, ethylene/butyl acrylate, ethylene/2-ethylhexyl methacrylate, ethylene/glycidyl acrylate, ethylene/glycidyl methacrylate, ethylene/methyl acrylate/glycidyl acrylate, ethylene/methyl methacrylate/glycidyl acrylate, ethylene/ethyl acrylate/glycidyl acrylate, ethylene/ethyl methacrylate/glycidyl acrylate, ethylene/butyl acrylate/glycidyl acrylate, ethylene/2-ethylhexyl methacrylate/glycidyl acrylate, ethylene/methyl acrylate/glycidyl methacrylate,

ethylene/methyl methacrylate/glycidyl methacrylate, ethylene/ethyl acrylate/glycidyl methacrylate, ethylene/ethyl methacrylate/glycidyl methacrylate, ethylene/butyl acrylate/glycidyl methacrylate, and ethylene/2-ethylhexyl methacrylate/glycidyl methacrylate.

The blend may contain ethylene/unsaturated ester copolymer (e.g., any one or more of any of the ethylene/unsaturated ester copolymers discussed in this Application) in an amount of at least about any of the following: 5, 10, 15, 20, 25, 30, 35, 40, and 45 wt. %; and at most about any of the following: 50, 45, 40, 35, 30, 25, 20, 15, and 10 wt. %, based on the weight of the blend.

In some embodiments, the one or more co-monomers are selected from glycidyl alkylacrylates, such as glycidyl methacrylate; alkyl acrylates, such as methyl acrylate, ethyl acrylate, propyl acrylate, and butyl acrylate; and combinations thereof. In some embodiments, the copolymer contains ethylene/methyl acrylate/glycidyl methacrylate, ethylene/butyl acrylate/glycidyl methacrylate, or ethylene/glycidyl acrylate. Graft copolymers can also be used, such as glycidyl methacrylate-grafted poly (ethylene octane).

Ethylene/methyl acrylate/glycidyl methacrylate and ethylene/glycidyl acrylate are available under the trade name LOTADER® AX8900 and LOTADER® AX8840. Ethylene/butyl acrylate/glycidyl methacrylate are available under the trade name Elvaloy PTW. The GMA-grafted poly (ethylene octane) is available from Shanghai Jianqiao Plastic Co, Ltd under the trade name Grafbond.

The content of the functionalized polyolefin copolymer in the PLA-based blends can vary. In some embodiments, the content of the functionalized polyolefin copolymer is from about 5 wt % to about 25 wt % of the blend, preferably from about 10 wt % to about 25 wt % of the blend, more preferably from about 15 wt % to about 25 wt % of the blend, most preferably from about 20 wt % to about 25 wt % of the blend. In some embodiments, the content of the functionalized polyolefin copolymer is about 20 wt % of the PLA-based blend.

C. Thermoplastic Elastomeric Block Copolymers

The blend may contain a thermoplastic elastomeric block copolymer. Thermoplastic elastomers are copolymers or polymer blends that exhibit both thermoplastic and elastomeric properties. In some embodiments, the thermoplastic elastomer block copolymers contain soft segments or blocks and hard segments or blocks. “Hard segment”, as used herein, refers to a monomeric, oligomeric, and/or polymeric segment or block that imparts rigidity and/or toughness to the resulting polymer. “Soft segment”, as used herein, refers to a monomeric, oligomeric, and/or polymeric segment or block that provides elasticity to the resulting polymer when attached to the hard segment.

In some embodiments, the block copolymer contains a polyamide as the hard segment and a polyether as the soft segment. Any polyether and polyamide segments can be used. Poly (ether amide) block copolymer includes block copolymer made by polycondensation reaction of a polyether diol and a carboxylic acid-terminated polyamide. For example, the poly (ether amide) copolymer may contain a linear and regular chain of a polyamide block containing a reoccurring moiety of formula —NH—(CH₂)ₙ—(CO)— wherein n is from about 5 to about 12 and a polyether block containing a recurring moiety of formula —(CH₂)ₘ—O— wherein m is from about 2 to about 4. For example, the polyether diol block may be prepared from a polybutylene oxide or a polypropylene oxide. Also, the polyether block may be selected from polyoxyethylene, polyoxypropylene, and polyoxytetramethylene. The carboxylic amide block may be prepared from a carboxylic acid-terminated nylon-12 (polylaurolactam) or nylon-6 (polycaprolactam). The polyamide block may also be selected from nylon-6/6,6, nylon-6,6, nylon-11, and nylon-12. The properties of poly (ether amide) block copolymer (e.g. flex modulus and melting point) may be modified, for example, by changing the nature of the polyamide block and the polyether block, and/or by changing the mass balance between these two blocks. Suitable poly (ether amide) block copolymer may contain only polyether blocks and polyamide blocks. Other suitable poly (ether amide) block copolymers may contain one or more additional comonomers or blocks other than polyether blocks and polyamide blocks, for example, polyester blocks resulting in poly (ether ester amide) block copolymer.

The poly (ether amide) block copolymer may have a melting point that is below the decomposition temperature of polylactic acid so that a blend of the poly (ether amide) block copolymer and polylactic acid may be processed and exposed to extrusion machinery temperatures without degrading the polylactic acid (The decomposition temperature of some grades of polylactic acid is believed to be around 250° C.). For example, the poly (ether amide) block copolymer may have a melting point of at most about 210, 200, 190, 180, 170, 160, 150, or 140° C.

In some embodiments, the polyamide block is polyamide 11, which can be obtained from renewable resources such as castor oil. Other suitable polyamides include, but are not limited to, polyamide 6.10 and polyamide 10.10. The polyether block may be polyethylene oxide, polypropylene oxide, polyoxytetramethylene, or combinations thereof. Depending on the source, these ingredients may include 20-94% carbon atoms from renewable resources.

Bio-based poly (ether amide) segmented block copolymers are available from Arkema Group under the trade name PEBAX®, such as 2533, 3533, 4033, 5512, and 5533, and PEBAX Rnew®, such as PEBAX Rnew® 55R53, Pebax® Rnew 40R53, Pebax® Rnew 35R53, Pebax® Rnew 70R53, Pebax® Rnew 72R53, Pebax® Rnew 65R53, Pebax® Rnew100. Pebax® Rnew with high bio-based carbon atoms content can be used.

Other thermoplastic elastomeric block copolymers include poly (ether ester) block copolymers containing polyester hard segments and polyether soft segments. In some embodiments, the polyester segments are the products of a diol, such as an alkane diol, and a diacid, such as alkane diacid. Suitable polyester segments, include but are not limited to, poly (butylene-co-isophthalate), poly (ethylene terephthalate) and poly (butylene 2,6-naphthalene dicarboxylate). Suitable polyether segments may include poly (ether glycols) like poly (ethylene glycol), poly (tetramethylene glycol) and poly (propylene glycol).

Thermoplastic elastomers containing poly(butylene terephthalate) and poly (ether glycol) segments, such as Hytrel® are available from DuPont in different grades, including Hytrel® 3078, Hytrel®4056, Hytrel®4068, Hytrel®4069, Hytrel®4556, Hytrel® 5526, Hytrel® 5556, and Hytrel®6356. Renewable resource based grades, Hytrel RS® 40F3 NC010 and Hytrel RS® 40F3 NC010, with 35-65% bio-based content are available and can be used to prepare the blends. 100% bio-based polyether esters may be commercially available and may also be used.

The content of the thermoplastic elastomeric segmented block copolymer is from about 5 wt % to about 20 wt % of the blend, preferably from about 5 wt % to about 15% of the blend, more preferably from about 8 wt % to about 12 wt % of the blend. In some embodiments, the content of the block copolymer is about 10 wt % of the blend.

### III. PLA-Based Composites

The blends described herein can be used to prepare PLA-based composites. The composites are prepared by combining the blends described above with one or more additives selected from fillers, such as natural fibers and/or mineral fillers; nucleating agents; chain extenders; and combinations there of to form the composites. The at least one filler may be one or both of a natural fiber and a mineral filler. The content by weight of the different ingredients of the PLA-based composite may vary as long as the resulting composite has an impact resistance or strength, and a heat resistance higher than those of the virgin or neat poly (lactic acid).

In one embodiment, the composites may contain up to 75 wt % bio-based content. Provided that the composites have improved or enhanced impact strength and HDT relative to virgin PLA, the composites may contain more than 75 wt % bio-based content. The PLA-based composites may be derived from a combination of a renewable (e.g., derived from a renewable resource) material along with a recycled material, a regrind material, or mixtures thereof.

In some embodiments, the composite contains both a nucleating agent and a natural fiber. The nucleating agent increases the crystallization speed of PLA, while the natural fiber improves the rigidity of PLA at high temperatures. The combination of natural fiber and nucleating agent can result in PLA composites having impact strengths in the range of about 60 to about 140 J/m and an HDT in the range of about 60 to about 115° C. The impact strength and HDT can be tailored by varying the amount and/or type of nucleating agent and/or fiber used.

A. Natural Fibers

The composites can contain one or more natural fibers. Exemplary natural fibers include, but are not limited to, bast fibers, leaf fibers, grass fibers (perennial grasses), straw fibers (agricultural residues), and seed/fruit fibers.

Perennial grasses include, but are not limited to, switchgrass and miscanthus. Agricultural residues include, but are not limited to, soy stalk, wheat straw, corn stover, soy hull, and oat hull.

Perennial grasses and agricultural residues include, but are not limited to, lignocellulosic fibers having about 35% cellulose and other constituents such as hemicellulose, lignin, pectin, protein and ash.

The natural fibers can have an average length from about 2 to about 10 mm, preferably from about 2 to about 6 mm, particularly for injection molding processes. However, fibers less than 2 mm and greater than 6 mm or 10 mm may also be used.

Natural fibers can be added to the PLA-based blend system directly without any surface treatment (e.g., devoid of surface treatment, such as chemical treatment) to achieve the desired performance. A mixture of two more fibers can also be used. This can enhance the performance of the composites while maintaining a balance between impact strength and HDT. This may especially be important in the case of fiber supply chain issues that can arise while using one particular type of fiber.

The content of the natural fiber(s) in the composite may be from about 0 wt % to about 35 wt %, preferably from about 0 wt % to about 30% of the composite, more preferably from about 0 wt % to about 25%, most preferably from about 0 wt % to about 15 wt %. When the natural fibers are present, the concentration can be from about 10 wt % to about 30 wt % of the composite, preferably from about 10 wt % to about 25 wt % of the composite, more preferably from about 10 wt % to about 20 wt % of the composite.

The use of natural fiber also reduces the cost of the final formulation, as up to 30 wt % of the composite can be replaced with these fibers as per the property requirements of the end product.

B. Mineral Fillers

The composite can also contain one or more mineral fillers. Suitable mineral fillers include those known to be useful in the compounding of polymers. Exemplary mineral fillers include, but are not limited to, talc, calcium carbonate, calcium sulphate, mica, magnesium oxysulphate, silica, kaolin and combinations thereof. In some embodiments, the mineral filler is magnesium oxysulphate, sold as HPR-803i by Milliken Chemical.

The content of the mineral filler(s) in the PLA-based composite is from about 0 percent by weight (wt %) to about 25 wt % of the composite. When the mineral filler is present, it can be present in an amount from about 5 wt % to about 25 wt % of the composite, preferably from about 5 wt % to about 20 wt % of the composite, more preferably from about 5 wt % to about 15 wt % of the composite.

C. Nucleating Agents

The composite can also contain one or more nucleating agents. Nucleating agents work by altering the way the PLA chains crystallize in the molten state. Nucleating agents provide sites around which the PLA chains can crystallize thereby increasing the crystallization temperature thus increasing the rate of crystallization. Certain mineral fillers can also act as nucleating agents. Exemplary nucleating agents include, but are not limited to, talc, aromatic sulfonate derivatives, precipitated calcium carbonate, metal salts of phenylphosphonic acid, and combinations thereof. Different grades of talc are available from Luzenac America Inc. Aromatic sulphonate derivatives, such as Lak-301 can be obtained from Takemoto Oil & Fat Co. Ltd. Precipitated calcium carbonate is sold by Specialty Minerals Inc. as Emforce® bio additive. Zinc salts of phenylphosphonic acid are manufactured by Nissan Chemical Industries Ltd. under the name Ecopromote®.

The content of the nucleating agent in the PLA-based composite is from about 1 percent by weight (wt %) to about 5 wt % of the composite.

D. Chain Extender

The composite can also contain one or more chain extenders. Chain extenders can improve the molar mass of the PLA and maintain the mechanical properties of the PLA in a well defined range. Chain extenders work by increasing the melt volume rate of the polymer. Exemplary chain extenders include, but are not limited to epoxy-functionalized styrene-acrylic oligomers available under the tradename Joncryl® from BASF, carbodiimides available under the tradename BioAdimide® from Rhein Chemie Corporation, and fast acting linear chain extenders available as Allinco® from DSM Research.

The content of the chain extender in the PLA-based composite is from about 0 percent by weight (wt %) to about 5 wt % of the composite. When the chain extended is present, it can be present in an amount from about 1 wt % to about 5 wt % of the composite, preferably from about 1 wt % to about 3 wt % of the composite.

### IV. Methods of Manufacturing Blends and Composites Containing the Blends

A. Polylactic Acid

Poly (lactic acid) can be made using a variety of techniques known in the art, such as polycondensation. In the polycondensation method, L-lactic acid, D-lactic acid, or a mixture of these, or lactic acid and one or more other hydroxycarboxylic acids, may be directly subjected to dehydropolycondensation to obtain a polylactic acid of a specific composition. For example, in the direct dehydration polycondensation process the lactic acid or other hydroxycarboxylic acids may be subjected to azeotropic dehydration condensation in the presence of an organic solvent, such as a diphenyl ether-based solvent. Such polymerization reaction, for example, may progress by removing water from the azeotropically distilled solvent and returning substantially anhydrous solvent to the reaction system.

Polylactic acid may also be made by ring-opening polymerization methods. In the ring-opening polymerization method, lactide (i.e., cyclic dimer of lactic acid) is polymerized via a polymerization adjusting agent and a catalyst to obtain polylactic acid. Lactide includes L-lactide (i.e., dimer of L-lactic acid), D-lactide (i.e., dimer of D-lactic acid), DL-lactide (i.e., mixture of L- and D-lactides), and meso-lactide (i.e., cyclic dimer of D- and L-lactic acids). These isomers can be mixed and polymerized to obtain polylactic acid having a desired composition and crystallinity. Any of these isomers may also be copolymerized by ring-opening polymerization with other cyclic dimers (e.g., glycolide, a cyclic dimer of glycolic acid) and/or with cyclic esters such as caprolactone, propiolactone, butyrolactone, and valerolactone.

B. Blends

The blend can be prepared using techniques known in the art. In some embodiments, prior to the processing, all the components were dried, for example, at 60-80° C. for at least 4 h. In some embodiments, the blends can be prepared by extrusion. In some embodiments, the components of the blend were extruded at a temperature from about 170° C. to about 200° C., preferably from about 185 to about 195° C. In one embodiment, the composites are prepared by co-extruding (a) poly (lactic acid) (PLA), (b) a thermoplastic elastomeric block copolymer, (c) a functionalized polyolefin copolymer.

The injection molding conditions can vary as well. In some embodiments, the injection molding conditions were as follows: melt temperature from about 170° C. to about 200° C., mold temperature from of about 30° C. and cooling time from about 30 to about 60 seconds.

In some embodiments, lab scale extrusions and injection moldings were performed on a micro twin-screw extruder and micro injection molder (DSM Research, Netherlands). The screw configuration in the extruder was co-rotating and was operated at a RPM of 100. Pilot scale extrusion can be carried out in a co-rotating twin-screw extruder (Leistritz, US) with a screw diameter of 27 mm. Two component injection molding machine (Arburg, Germany) can be used for the pilot scale injection molding.

C. Composites

The composites can be prepared using techniques known in the art. The PLA resin can be dried prior to extrusion to form the composite. In some embodiments, the resin is dried at a temperature from about 60° C. to 80° C. for a period of time from about 4 to about 6 hours.

In one embodiment, the composites are prepared by co-extruding a blend containing (a) poly (lactic acid) (PLA), (b) a thermoplastic elastomeric block copolymer, and (c) a functionalized polyolefin copolymer, with at least one filler (e.g., natural fibers and/or mineral fillers), nucleating agent, and/or chain extender. In those embodiments where the filler is or contains one or more natural fibers, the fiber may be added to the PLA-based blend directly without any surface treatment to achieve the desired performance. After extrusion, the extruded pellets can be dried, for example at 80° C. for at least 42 hours.

In some embodiments, the PLA-based blend forms a matrix or continuous phase of the composite and the fillers and/or other additives form a dispersed phase.

The method may further include injection molding of the extrudate so as to obtain a molded PLA-based composition having improved or enhanced HDT and impact strength relative to neat or virgin PLA. The PLA-based composites may be used for manufacturing a molded article or product having enhanced impact strength and enhanced HDT relative to neat PLA. The method of manufacturing a molded product may include a step of molding the above-described composites by injection molding, extrusion molding, blow molding, vacuum molding, compression molding, and so forth.

The injection molding conditions may vary. However, in some embodiments, the injection molding conditions may be as follows: melt temperature from about 170° C. to about 200° C., mold temperature from about 60° C. to about 120° C., and cooling time from about 30 seconds to about 90 seconds.

Lab scale extrusion and injection molding can be done using a variety of equipment known in the art. In some embodiments, lab scale extrusions and injection moldings were performed on a micro twin-screw extruder and micro injection molder (DSM Research, Netherlands). The screw configuration in the extruder was co-rotating and was operated at a RPM of 100. Pilot scale extrusion can be carried out in a co-rotating twin-screw extruder (Leistritz, US) with a screw diameter of 27 mm. Two component injection molding machine (Arburg, Germany) can be used for the pilot scale injection molding.

### V. Methods of Using the Composites

The composites described herein can be used to prepare an article of manufacture that is made from plastics and or plastic/synthetic fillers and fibers. Examples include but are not limited to, injection molded articles, such as car parts, toys, consumer products, building materials, etc.

In one embodiment, the composites may contain up to 75 wt % bio-based content. Provided that the composites have improved or enhanced impact strength and HDT relative to virgin PLA, the composites may contain more than 75 wt % bio-based content. The PLA-based composites may be derived from a combination of a renewable (e.g., derived from a renewable resource) material along with a recycled material, a regrind material, or mixtures thereof.

In some embodiments, the composite contains both a nucleating agent and a natural fiber. The nucleating agent increases the crystallization speed of PLA, while the natural fiber improves the rigidity of PLA at high temperatures. The combination of natural fiber and nucleating agent can result in PLA composites having impact strengths in the range of about 60 to about 140 J/m and an HDT in the range of about 60 to about 115° C. The impact strength and HDT can be tailored by varying the amount and/or type of nucleating agent and/or fiber used.

### EXAMPLES

### Materials and Methods

Tensile and flexural properties of the neat PLA, blends and composites were measured using Instron Instrument Model 3382 following ASTM standards D 638 and D 790, respectively. Tensile tests for the neat PLA and PLA blends were carried out at room temperature with a gauge length of 50 mm and at a crosshead speed of 50 mm/min while PLA composites were tested at 5 mm/min. A span length of 52 mm and crosshead speed of 14 mm/min were used for flexural tests.

Notched Izod impact tests as per ASTM D 256 at room temperature were accomplished using TMI 43-02 Monitor Impact Tester with a 5 ft-lb pendulum. HDT was evaluated using a dynamic mechanical analyzer (DMA Q800) supplied by TA Instruments in three-point bending mode at a constant applied load of 0.455 MPa. The samples were heated from room temperature to the desired temperature at a ramp rate of 2° C. min-1. HDT was reported as the temperature at which a deflection of 0.25 mm occurred.

The results reported herein are average values obtained after testing at least 5 samples for tensile and flexural properties, 6 samples for impact strength and 3 samples for HDT.

### Example 1

### Preparation of PLA Blends

A PLA-based blend was prepared having the following composition: (a) 70 wt % PLA (Ingeo® 3001 D), (b) 20 wt % functionalized polyolefin copolymer (Lotader® AX8900) and (c) 10 wt % thermoplastic elastomeric segmented block copolymer (Pebax® Rnew 35R53). This blend is referred to as Example 1A in Table 1.

A second blend was prepared having the following composition: (a) 70 wt % PLA (Ingeo 3001 D), (b) 20 wt % functionalized polyolefin copolymer (Lotader® AX8900) and (c) 10 wt % thermoplastic elastomeric segmented block copolymer (Hytrel® 3078). This blend is referred to as Example 1B in Table 1.

The blends were prepared by extrusion followed by injection molding in lab scale processing machines. The extrusion temperature was 190° C. and injection temperature was 190° C. The mold temperature was 30° C. The cooling time was 30 seconds.

### Example 2

### Preparation of PLA Composites Containing PLA Blend, Natural Fibers and Nucleating Agent

PLA composite 2A in Table 1 was prepared by combining the following materials: (a) 89 wt % of PLA blend 1A; (b) 10 wt % of natural fiber (miscanthus); and (c) 1 wt % nucleating agent (LAK-301). The composites were manufactured in lab scale processing machines with an extrusion temperature of 190° C. and upon injection molding, the injection temperature was 190° C., the mold temperature was 110° C., and the cooling time was 60 seconds.

PLA composite 2B in Table 1 was prepared by combining the following materials: (a) 84 wt % of PLA blend 1B; (b) 15 wt % of natural fiber (oat hull); and (c) 1 wt % nucleating agent (LAK-301). The composites were manufactured in lab scale processing machines with an extrusion temperature of 190° C. and upon injection molding, the injection temperature was 190° C., the mold temperature was 110° C., and the cooling time was 60 seconds.

PLA composite 2C in Table 1 was prepared by combining the following materials: (a) 89 wt % of PLA blend 1A; (b) 10 wt % of natural fiber (coir); and (c) 1 wt % nucleating agent (LAK-301). The composites were manufactured in lab scale processing machines with an extrusion temperature of 190° C. and upon injection molding, the injection temperature was 190° C., the mold temperature was 110° C., and the cooling time was 60 seconds.

PLA composite 2D in Table 1 was prepared by combining the following materials: (a) 73 wt % of PLA blend 1B; (b) 25 wt % of natural fiber (miscanthus); and (c) 1 wt % nucleating agent (LAK-301). The composites were manufactured in lab scale processing machines with an extrusion temperature of 190° C. and upon injection molding, the injection temperature was 190° C., the mold temperature was 90° C., and the cooling time was 30 seconds.

PLA composite 2E in Table 1 was prepared by combining the following materials: (a) 85 wt % of PLA blend 1B; (b) 10 wt % of natural fiber (oat hull); and (c) 5 wt % nucleating agent (LAK-301). The composites were manufactured in lab scale processing machines with an extrusion temperature of 190° C. and upon injection molding, the injection temperature was 190° C., the mold temperature was 90° C., and the cooling time was 30 seconds.

PLA composite 2F in Table 1 was prepared by combining the following materials: (a) 85 wt % of PLA blend 1B; (b) 10 wt % of natural fiber (miscanthus); and (c) 1 wt % nucleating agent (LAK-301). The composites were manufactured in lab scale processing machines with an extrusion temperature of 190° C. and upon injection molding, the injection temperature was 190° C., the mold temperature was 120° C., and the cooling time was 60 seconds.

### Example 3

### Preparation of PLA Composites Containing PLA Blend, Natural Fiber, Nucleating Agent, and Chain Extender

PLA composite 3A was prepared by combining the following materials: (a) 87 wt % of PLA blend 1A; (b) 10 wt % natural fiber (miscanthus); (c) 1 wt % nucleating agent (LAK-301) and (d) 2 wt % chain extender (BioAdimide 500 XT). The composites were manufactured in lab scale processing machines with an extrusion temperature of 190° C. and upon injection molding, the injection temperature was 190° C., the mold temperature was 110° C., and the cooling time was 60 seconds.

PLA composite 3B was prepared by combining the following materials: (a) 82 wt % of PLA blend 1B; (b) 15 wt % natural fiber (oat hull); (c) 1 wt % nucleating agent (LAK-301), and (d) 2 wt % chain extender (BioAdimide 500 XT). The composites were manufactured in lab scale processing machines with an extrusion temperature of 190° C. and upon injection molding, the injection temperature was 190° C., the mold temperature was 110° C., and the cooling time was 60 seconds.

PLA composite 3C was prepared by combining the following materials: (a) 87 wt % of PLA blend 1A; (b) 10 wt % natural fiber (miscanthus); (c) 1 wt % nucleating agent (LAK-301) and (d) 2 wt % chain extender (BioAdimide 500 XT). The composites were manufactured in pilot scale processing machines with an extrusion temperature of 170° C. and upon injection molding, the injection temperature was 190° C., the mold temperature was 110° C., and the cooling time was 60 seconds.

### Example 4

### Preparation of PLA Composites Containing PLA Blend, Mineral Filler, and Nucleating Agent

PLA composite 4 was prepared containing the following materials: (a) 80 wt % of PLA blend 1A; (b) 15 wt % of mineral filler (surface modified talc, Luzenac Mistron CB); and (c) 1 wt % nucleating agent (LAK-301). The composites were manufactured in lab scale processing machines with an extrusion temperature of 190° C. and upon injection molding, the injection temperature was 190° C., the mold temperature was 110° C., and the cooling time was 60 seconds.

### Example 5

### Preparation of PLA Composites Containing PLA Blend, Natural Fiber, Mineral Filler, and Nucleating Agent

PLA composite 5 was prepared containing the following materials: (a) 75 wt % of PLA blend 1A; (b) 20 wt % natural fiber (miscanthus); (c) 4 wt % of mineral filler (surface modified talc, Luzenac Mistron CB); and (c) 1 wt % nucleating agent (LAK-301). The composites were manufactured in lab scale processing machines with an extrusion temperature of 190° C. and upon injection molding, the injection temperature was 190° C., the mold temperature was 110° C., and the cooling time was 60 seconds.

### Example 6

### Preparation of PLA Composites Containing PLA Blend, Natural Fiber, Mineral Filler, Nucleating Agent, and Chain Extender

PLA composite 6 was prepared containing the following materials: (a) 75 wt % of PLA blend from Example 1A; (b) 20 wt % natural fiber (miscanthus); (c) 4 wt % of mineral filler (surface modified talc, Luzenac Mistron CB); and (c) 1 wt % nucleating agent (LAK-301). The composites were manufactured in lab scale processing machines with an extrusion temperature of 190° C. and upon injection molding, the injection temperature was 190° C., the mold temperature was 110° C., and the cooling time was 60 seconds.

### Example 7

### Evaluation of Tensile Properties of PLA Blends and Composites Containing the Same

The tensile properties of neat PLA, PLA blends, and composites containing PLA blends were measured. The results are shown in Table 1.

| | Tensile | Tensile | | Flexural | Flexural | |
|---|---|---|---|---|---|---|
| | strength | Modulus | Elongation | strength | modulus | |
| | (MPa) | (GPa) | at break | (MPa) | (GPa) | |
| | ASTM | ASTM | (%) ASTM | ASTM | ASTM | Renewable |
| Example | D638 | D638 | D638 | D790 | D790 | content (%) |
| Neat PLA | 78.1 ± 2.07 | 3.05 ± 0.03 | 3.25 ± 0.2 | 120.1 ± 0.9 | 3.74 ± 0.03 | 100 |
| Example 1A | 42.5 ± 0.71 | 1.81 ± 0.03 | 71.6 ± 10.9 | 58.6 ± 0.19 | 2.45 ± 0.01 | 73.1 |
| (Blend 1) | | | | | | |
| Example 1B | 47.3 ± 2.40 | 1.98 ± 0.08 | 94.2 ± 14.1 | 60.78 ± 0.8 | 2.25 ± 0.04 | 75.0 |
| (Blend 2) | | | | | | |
| Example 2A | 32.9 ± 1.88 | 2.24 ± 0.10 | 4.2 ± 0.41 | 58.15 ± 1.6 | 2.72 ± 0.93 | 75.0 |
| (Blend1 + natural | | | | | | |
| fiber + nucleating | | | | | | |
| agent) | | | | | | |
| Example 2B | 30.6 ± 1.9 | 3.6 ± 0.2 | 2.51 ± 0.44 | 60.0 ± 2.73 | 2.68 ± 0.11 | 73.0 |
| (Blend2 + natural | | | | | | |
| fiber + nucleating | | | | | | |
| agent) | | | | | | |
| Example 2C | 30.7 ± 1.3 | 2.77 ± 0.06 | 2.57 ± 0.55 | 58.0 ± 1.27 | 2.52 ± 0.03 | 75 |
| (Blend1 + natural | | | | | | |
| fiber + nucleating | | | | | | |
| agent) | | | | | | |
| Example 3A | 33.8 ± 2.89 | 2.70 ± 0.14 | 4.1 ± 1.2 | 59.1 ± 1.0 | 2.86 ± 0.09 | 73.6 |
| (Blend1 + natural | | | | | | |
| fiber + nucleating | | | | | | |
| agent + chain | | | | | | |
| extender) | | | | | | |
| Example 3B | 28.7 ± 1.55 | 2.55 ± 0.14 | 2.95 ± 0.09 | 54.7 ± 3.19 | 2.56 ± 0.11 | 76.5 |
| (Blend2 + natural | | | | | | |
| fiber + nucleating | | | | | | |
| agent + chain | | | | | | |
| extender) | | | | | | |
| Example 3C | 32.7 ± 0.43 | 2.76 ± 0.04 | 3.09 ± 0.47 | 59.8 ± 1.87 | 2.71 ± 0.05 | 73.6 |
| (Blend1 + natural | | | | | | |
| fiber + nucleating | | | | | | |
| agent + chain | | | | | | |
| extender)-pilot | | | | | | |
| scale processing | | | | | | |
| Example 4 | 28.3 ± 1.04 | 2635 ± 0.05 | 10.1 ± 1.36 | 57.2 ± 0.74 | 2.46 ± 0.09 | 58.48 |
| (Blend1 + mineral | | | | | | |
| filler + nucleating | | | | | | |
| agent) | | | | | | |
| Example 5 | 31.1 ± 1.19 | 2.41 ± 0.02 | 3.7 ± 0.81 | 54.1 ± 1.32 | 2.95 ± 0.08 | 74.8 |
| (Blend1 + natural | | | | | | |
| fiber + mineral | | | | | | |
| filler + nucleating | | | | | | |
| agent) | | | | | | |
| Example 6 | 28.8 ± 1.46 | 2.75 ± 0.16 | 3.68 ± 0.81 | 55.7 ± 1.63 | 2.38 ± 0.08 | 70.0 |
| (Blend1 + natural | | | | | | |
| fiber + mineral | | | | | | |
| filler + nucleating | | | | | | |
| agent + chain | | | | | | |
| extender) | | | | | | |

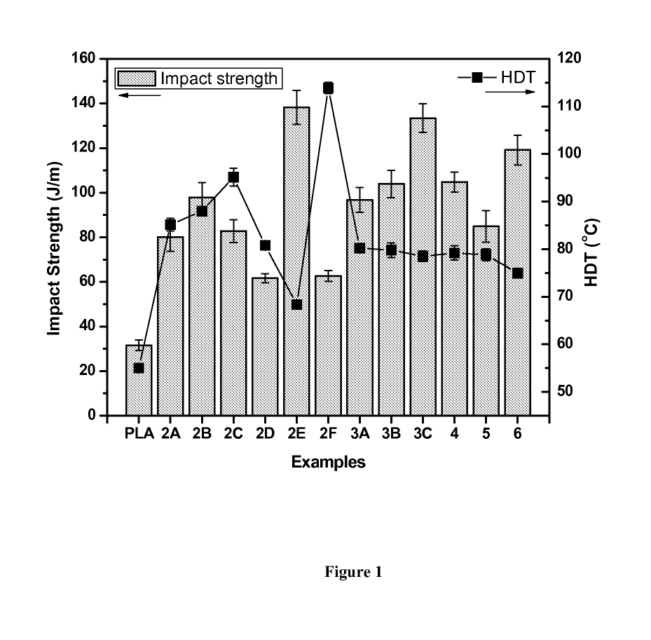

FIG. 1 is a graph showing the impact strength and HDT of neat PLA and PLA composites 2A-2F, 3A-3C, and 4-6.

1. A polylactic acid (PLA)-based blend comprising (a) a PLA; (b) a thermoplastic elastomeric block copolymer; and (c) functionalized polyolefin copolymer.

2. The blend of claim 1, comprising (a) the PLA in an amount from about 65 wt % to about 90 wt % of the blend; (b) the thermoplastic elastomer block copolymer in an amount from about 5 wt % to about 20 wt % of the blend; and (c) the functionalized polyolefin copolymer in an amount from about 5 wt % to about 25 wt % of the blend.

3. The blend of claim 1, wherein the PLA is selected from virgin PLA, recycled PLA, or a combination thereof.

4. (canceled)

5. The blend of claim 3, wherein the PLA is a mixture of virgin PLA and recycled PLA, wherein the concentration of recycled PLA is from about 10% to about 30% by weight of the mixture of virgin PLA and recycled PLA.

6. The blend of claim 1, wherein the thermoplastic elastomeric block copolymer comprises hard segments and soft segments.

7. The blend of claim 6, wherein the hard segments comprise a polyamide or a polyester.

8-10. (canceled)

11. The blend of claim 7, wherein the hard segments comprises the polyester, and wherein the polyester is the product of the reaction of a diacid and a diol.

12. The blend of claim 11, wherein the polyester comprises a poly(alkylene terephthalate).

13. (canceled)

14. The blend of claim 6, wherein the soft segment comprises a polyether.

15. The blend of claim 14, wherein the polyether is a polyether glycol.

16. (canceled)

17. The blend of claim 1, wherein the blend exhibits non-break impact behavior when tested with a 5 ft-lb pendulum.

18. The blend of claim 17, wherein the heat distortion temperature of the blend is substantially the same as virgin PLA.

19. The blend of claim 1, wherein the blend is in the form of a core-shell structure or partial encapsulation structure, wherein the thermoplastic elastomeric block copolymer forms the core of the structure, and the functionalized polyolefin copolymer forms the shell of the structure.

20. (canceled)

21. The blend of claim 1, wherein the bio-based content ranges from about 70 wt % to about 93 wt % of the blend.

22. A composite comprising the PLA-based blend of claim 1 and at least one of a filler, a nucleating agent, a chain extender, or any combinations thereof.

23. The composite of claim 22, wherein the composite comprises the PLA-based blend and the filler, and wherein the filler is selected from a natural fiber, a mineral filler, or any combinations thereof.

24-26. (canceled)

27. The composite of claim 23, wherein the filler is one or more natural fibers selected from the group consisting of bast fibers, leaf fibers, grass fibers, straw fibers, seed fibers, fruit fibers, and any combinations thereof.

28-31. (canceled)

32. The composite of claim 23, wherein the filler is the mineral filler and wherein the mineral filler is selected from the group consisting of talc, calcium carbonate, calcium sulphate, mica, magnesium oxysulphate, silica, kaolin and combinations thereof.

33-34. (canceled)

35. The composite of claim 23, wherein the composite further comprises a nucleating agent, and wherein the nucleating agent is selected from the group consisting of talc, aromatic sulfonate derivatives, precipitated calcium carbonate, metal salts of phenylphosphonic acid, and combinations thereof.

36. The composite of claim 35, wherein the concentration of the nucleating agent is from about 1 wt % to about 5 wt % of the composite.

37. (canceled)

38. The composite of claim 34, wherein the composite further comprises a chain extender, and wherein the chain extender is selected from the group consisting of epoxy-functionalized styrene-acrylic oligomers, carbodiimides, carbonyl bis(1-caprolactam), and combinations thereof.

39. The composite of claim 38, wherein the concentration of the chain extender is from about 0 wt % to about 5 wt % of the composite.

40. The composite of claim 22, wherein the composite comprises from about 70 wt % to about 94 wt % of the PLA-based blend, from about 5 wt % to about 25 wt % of the filler, and from about 1 wt % to about 5 wt % of the nucleating agent of the composite.

41-44. (canceled)

45. The composite of claim 22, wherein the impact strength of the composite is from about 60 J/m to about 140 J/m and the heat distortion temperature (HDT) of the composite ranges from about 60 to about 114° C.

46-50. (canceled)

51. An article of manufacture comprising the composite of claim 22.
